(19) United States
(12) Patent Application Publication
(10) Pub. No.: US 2007/0103056 A1
(43) Pub. Date: May 10, 2007

(54) OLED device having improved light output

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/269,018

(22) Filed: Nov. 8, 2005

(51) Int. Cl. H05B 33/00; H05B 33/22

(52) U.S. Cl. 313/503; 313/504; 313/506

(57) ABSTRACT

A full-color organic light-emitting diode (OLED) device, comprising: an OLED having a first patterned electrode defining independently controllable light-emitting sub-pixels, and a second electrode, wherein at least one of the first or second electrodes is transparent and one or more layers of unpatterned organic material formed between the electrodes; wherein the organic material layer(s) emit broadband light that contains blue and at least one other color of light, and a color-change material that converts relatively higher frequency components of the broadband light to green light is correspondingly patterned with at least one of the sub-pixels to form a green sub-pixel, a color-change material that converts relatively higher frequency components of the broadband light to red light is correspondingly patterned with at least one other of the sub-pixels to form a red sub-pixel, and a blue color filter directly filtering emitted broadband light is correspondingly patterned with at least one additional other of the sub-pixels to form a blue sub-pixel.

### FIELD OF THE INVENTION

The present invention relates to organic light-emitting diode (OLED) devices, and more particularly, to OLED device structures for improving light output.

### BACKGROUND OF THE INVENTION

Organic light-emitting diodes (OLEDs) are a promising technology for flat-panel displays and area illumination lamps. The technology relies upon thin-film layers of organic materials coated upon a substrate. OLED devices generally can have two formats known as small molecule devices such as disclosed in U.S. Pat. No. 4,476,292 and polymer OLED devices such as disclosed in U.S. Pat. No. 5,247,190. Either type of OLED device may include, in sequence, an anode, an organic EL element, and a cathode. The organic EL element disposed between the anode and the cathode commonly includes an organic hole-transporting layer (HTL), an emissive layer (EL) and an organic electron-transporting layer (ETL). Holes and electrons recombine and emit light in the EL layer. Tang et al. (Appl. Phys. Lett., 51, 913 (1987), Journal of Applied Physics, 65, 3610 (1989), and U.S. Pat. No. 4,769,292) demonstrated highly efficient OLEDs using such a layer structure. Since then, numerous OLEDs with alternative layer structures, including polymeric materials, have been disclosed and device performance has been improved.

Light is generated in an OLED device when electrons and holes that are injected from the cathode and anode, respectively, flow through the electron transport layer and the hole transport layer and recombine in the emissive layer. Many factors determine the efficiency of this light generating process. For example, the selection of anode and cathode materials can determine how efficiently the electrons and holes are injected into the device; the selection of ETL and HTL can determine how efficiently the electrons and holes are transported in the device, and the selection of EL can determine how efficiently the electrons and holes be recombined and result in the emission of light, etc.

OLED devices can employ a variety of light-emitting organic materials patterned over a substrate that emit light of a variety of different frequencies, for example red, green, and blue, to create a full-color display. However, patterned deposition is difficult, requiring, for example, expensive metal masks. Alternatively, it is known to employ a combination of emitters, or an unpatterned broad-band emitter, to emit white light together with patterned color filters, for example red, green, and blue, to create a full-color display. The color filters may be located on the substrate, for a bottom-emitter, or on the cover, for a top-emitter. For example, U.S. Pat. No. 6,392,340 entitled “Color Display Apparatus having Electroluminescence Elements” issued May 21, 2002 illustrates such a device. However, such designs are relatively inefficient since approximately two thirds of the light emitted may be absorbed by the color filters.

In yet another alternative means of providing a full-color OLED device, an OLED device may employ a single high-frequency light emitter together with color-change materials to provide a variety of color light output. The color-change materials absorb the high-frequency light and re-emit light at lower frequencies. For example, an OLED device may emit blue light suitable for a blue sub-pixel and employ a green color-change materials to absorb blue light to emit green light and employ a red color change materials to absorb blue light to emit red light. The color-change materials may be combined with color filters to further improve the color of the emitted light and to absorb incident light to improve device contrast. U.S. patent application No. 20040233139A1 discloses a color conversion member which is improved in the prevention of a deterioration in color conversion function, the prevention of reflection of external light, and color rendering properties. The color conversion member comprises a transparent substrate, two or more types of color conversion layers, and a color filter layer. The color conversion layers function to convert incident lights for respective sub-pixels to outgoing lights of colors different from the incident lights. The two or more types of color conversion layers are arranged on said transparent substrate. The color filter layer is provided on the transparent substrate side of any one of the color conversion layers or between the above any one of the color conversion layers and the color conversion layers adjacent to the above any one the color conversion layers. US 20050057177 also describes the use of color change materials in combination with color filters.

It is also known to employ color-change materials in concert with micro-cavity structures having blue or blue-green emitters as described in U.S. Pat. No. 6,111,361. In this arrangement, a blue color filter is provided to purify the light from the blue sub-pixels, while color-change materials are provided to emit the green and red light in response to blue or blue-green light absorption. U.S. 2005/0140275A1 describes the use of red, green, and blue conversion layers for converting white light into three primary color of red, green, and blue light. However, color change materials do not always provide the optimal desired color of light emission, may absorb desired light, can be expensive, and are not completely efficient so that the conversion of light from one frequency to another may be less than desired. It may also be difficult to provide blue or white emitters with the desired energy characteristics.

It has also been found, that one of the key factors that limits the efficiency of OLED devices is the inefficiency in extracting the photons generated by the electron-hole recombination out of the OLED devices. Due to the high optical indices of the organic materials used, most of the photons generated by the recombination process are actually trapped in the devices due to total internal reflection. These trapped photons never leave the OLED devices and make no contribution to the light output from these devices. Because light is emitted in all directions from the internal layers of the OLED, some of the light is emitted directly from the device, and some is emitted into the device and is either reflected back out or is absorbed, and some of the light is emitted laterally and trapped and absorbed by the various layers comprising the device. In general, up to 80% of the light may be lost in this manner.

A typical OLED device uses a glass substrate, a transparent conducting anode such as indium-tin-oxide (ITO), a stack of organic layers, and a reflective cathode layer. Light generated from the device is emitted through the glass substrate. This is commonly referred to as a bottom-emitting device. Alternatively, a device can include a substrate, a reflective anode, a stack of organic layers, and a top transparent cathode layer. Light generated from the device is emitted through the top transparent electrode. This is commonly referred to as a top-emitting device. In these typical devices, the index of the ITO layer, the organic layers, and the glass is about 2.0, 1.7, and 1.5 respectively. It has been estimated that nearly 60% of the generated light is trapped by internal reflection in the ITO/organic EL element, 20% is trapped in the glass substrate, and only about 20% of the generated light is actually emitted from the device and performs useful functions.

In any of these OLED structures, the problem of trapped light remains. Referring to FIG. 9, a bottom-emitting OLED device as known in the prior art is illustrated having a substrate 10 (either reflective, transparent, or opaque), a transparent first electrode 12, one or more layers 14 of organic material, one of which is light-emitting, a reflective second electrode 16, a gap 19 and an encapsulating cover 20. The gap 19 is typically filled with desiccating material. Light emitted from one of the organic material layers 14 can be emitted directly out of the device, through the transparent substrate 10, as illustrated with light ray 1. Light may also be emitted and internally guided in the transparent substrate 10 and organic layers 14, as illustrated with light ray 2. Additionally, light may be emitted and internally guided in the layers 14 of organic material, as illustrated with light ray 3. Light rays 4 emitted toward the reflective electrode 16 are reflected by the reflective first electrode 12 toward the substrate 10 and follow one of the light ray paths 1, 2, or 3. In some prior-art embodiments, the electrode 16 may be opaque and/or light absorbing. This OLED display embodiment has been commercialized, for example in the Eastman Kodak LS633 digital camera. The bottom-emitter embodiment shown may also be implemented in a top-emitter configuration with a transparent cover and top electrode 16.

A variety of techniques have been proposed to improve the out-coupling of light from thin-film light emitting devices. For example, diffraction gratings have been proposed to control the attributes of light emission from thin polymer films by inducing Bragg scattering of light that is guided laterally through the emissive layers; see “Modification of polymer light emission by lateral microstructure” by Safonov et al., Synthetic Metals 116, 2001, pp. 145-148, and “Bragg scattering from periodically microstructured light emitting diodes” by Lupton et al., Applied Physics Letters, Vol. 77, No. 21, Nov. 20, 2000, pp. 3340-3342. Brightness enhancement films having diffractive properties and surface and volume diffusers are described in WO0237568 A1 entitled “Brightness and Contrast Enhancement of Direct View Emissive Displays” by Chou et al., published May 10, 2002. The use of micro-cavity techniques is also known; for example, see “Sharply directed emission in organic electroluminescent diodes with an optical-microcavity structure” by Tsutsui et al., Applied Physics Letters 65, No. 15, Oct. 10, 1994, pp. 1868-1870. However, none of these approaches cause all, or nearly all, of the light produced to be emitted from the device. Moreover, such diffractive techniques cause a significant frequency dependence on the angle of emission so that the color of the light emitted from the device changes with the viewer's perspective. Co-pending, commonly assigned U.S. Ser. No. 11/095,166 (docket 88,488), filed Mar. 31, 2005, describes the use of a micro-cavity OLED device together with a color filter having scattering properties and intended to reduce the angular dependence and color purity of the OLED. However, such a design does not improve the efficiency of the device due to absorption by the color filters.

Reflective structures surrounding a light-emitting area or sub-pixel are referenced in U.S. Pat. No. 5,834,893 issued Nov. 10, 1998 to Bulovic et al. and describe the use of angled or slanted reflective walls at the edge of each sub-pixel. Similarly, Forrest et al. describe sub-pixels with slanted walls in U.S. Pat. No. 6,091,195 issued Jul. 18, 2000. These approaches use reflectors located at the edges of the light emitting areas. However, considerable light is still lost through absorption of the light as it travels laterally through the layers parallel to the substrate within a single sub-pixel or light emitting area.

Scattering techniques are also known. Chou (International Publication Number WO 02/37580 A1) and Liu et al. (U.S. patent application Publication No. 2001/0026124 A1) taught the use of a volume or surface scattering layer to improve light extraction. The scattering layer is applied next to the organic layers or on the outside surface of the glass substrate and has optical index that matches these layers. Light emitted from the OLED device at higher than critical angle that would have otherwise been trapped can penetrate into the scattering layer and be scattered out of the device. The efficiency of the OLED device is thereby improved but still has deficiencies as explained below.

U.S. Pat. No. 6,787,796 entitled “Organic electroluminescent display device and method of manufacturing the same” by Do et al issued 20040907 describes an organic electroluminescent (EL) display device and a method of manufacturing the same. The organic EL device includes a substrate layer, a first electrode layer formed on the substrate layer, an organic layer formed on the first electrode layer, and a second electrode layer formed on the organic layer, wherein a light loss preventing layer having different refractive index areas is formed between layers of the organic EL device having a large difference in refractive index among the respective layers. U.S. patent application Publication No. 2004/0217702 entitled “Light extracting designs for organic light emitting diodes” by Garner et al., similarly discloses use of microstructures to provide internal refractive index variations or internal or surface physical variations that function to perturb the propagation of internal waveguide modes within an OLED. When employed in a top-emitter embodiment, the use of an index-matched polymer adjacent the encapsulating cover is disclosed.

Light-scattering layers used externally to an OLED device are described in U.S. patent application Publication No. 2005/0018431 entitled “Organic electroluminescent devices having improved light extraction” by Shiang and U.S. Pat. No. 5,955,837 entitled “System with an active layer of a medium having light-scattering properties for flat-panel display devices” by Horikx, et al. These disclosures describe and define properties of scattering layers located on a substrate in detail. Likewise, U.S. Pat. No. 6,777,871 entitled “Organic Electro Luminescent Devices with Enhanced Light Extraction” by Duggal et al., describes the use of an output coupler comprising a composite layer having specific refractive indices and scattering properties. While useful for extracting light, this approach will only extract light that propagates in the substrate (illustrated with light ray 2) and will not extract light that propagates through the organic layers and electrodes (illustrated with light ray 3).

It is also known to employ scattering materials within color filters to combine the functions into a single layer. For example, U.S. Pat. No. 6,731,359 describes color filters that include light scattering fine particles and has a haze of 10 to 90. The inclusion of the light scattering fine particles within the color filter can impart a light scattering function to the color filter per se. This can eliminate the need to provide a front scattering plate on the color filter (in its viewer side). Further, a deterioration in color properties caused by light scattering can be surely compensated for by the color property correction of the colored layer per se and/or by the correction of color properties through the addition of a colorant. This is suitable for surely preventing a deterioration in color properties of the color filter per se.

However, scattering techniques, by themselves, cause light to pass through the light-absorbing material layers multiple times where they are absorbed and converted to heat. Moreover, trapped light may propagate a considerable distance horizontally through the cover, substrate, or organic layers before being scattered out of the device, thereby reducing the sharpness of the device in pixellated applications such as displays. For example, as illustrated in FIG. 10, a prior-art pixellated bottom-emitting OLED device may include a plurality of independently controlled sub-pixels 50, 52, 54, 56, and 58 and a scattering layer 22 located between the transparent first electrode 12 and the substrate 10. A light ray 5 emitted from the light-emitting layer may be scattered multiple times by scattering layer 22, while traveling through the substrate 10, organic layer(s) 14, and transparent first electrode 12 before it is emitted from the device. When the light ray 5 is finally emitted from the device, the light ray 5 has traveled a considerable distance through the various device layers from the original sub-pixel 30 location where it originated to a remote sub-pixel 38 where it is emitted, thus reducing sharpness. Most of the lateral travel occurs in the substrate 10, because that is by far the thickest layer in the package. Also, the amount of light emitted is reduced due to absorption of light in the various layers.

U.S. patent application Publication No. 2004/0061136 entitled “Organic light emitting device having enhanced light extraction efficiency” by Tyan et al., describes an enhanced light extraction OLED device that includes a light scattering layer. In certain embodiments, a low index isolation layer (having an optical index substantially lower than that of the organic electroluminescent element) is employed adjacent to a reflective layer in combination with the light scattering layer to prevent low angle light from striking the reflective layer, and thereby minimize absorption losses due to multiple reflections from the reflective layer. The particular arrangements, however, may still result in reduced sharpness of the device.

Co-pending, commonly assigned U.S. Ser. No. 11/065,082 (Docket 89,211), filed Feb. 24, 2005, describes the use of a transparent low-index layer having a refractive index lower than the refractive index of the encapsulating cover or substrate through which light is emitted and lower than the organic layers to enhance the sharpness of an OLED device having a scattering element. US 20050194896 describes a nano-structure layer for extracting radiated light from a light-emitting device together with a gap having a refractive index lower than an average refractive index of the emissive layer and nano-structure layer. Such disclosed designs still, however, do not completely optimize the use of emitted light, particularly for displays with four-color pixels including a white emitter.

There is a need therefore for an improved organic light-emitting diode device structure that avoids the problems noted above and improves the efficiency and sharpness of the device.

### SUMMARY OF THE INVENTION

In accordance with one embodiment, the invention is directed towards a full-color organic light-emitting diode (OLED) device, comprising: an OLED having a first patterned electrode defining independently controllable light-emitting sub-pixels, and a second electrode, wherein at least one of the first or second electrodes is transparent and one or more layers of unpatterned organic material formed between the electrodes; wherein the organic material layer(s) emit broadband light that contains blue and at least one other color of light, and a color-change material that converts relatively higher frequency components of the broadband light to green light is correspondingly patterned with at least one of the sub-pixels to form a green sub-pixel, a color-change material that converts relatively higher frequency components of the broadband light to red light is correspondingly patterned with at least one other of the sub-pixels to form a red sub-pixel, and a blue color filter directly filtering emitted broadband light is correspondingly patterned with at least one additional other of the sub-pixels to form a blue sub-pixel.

### ADVANTAGES

The present invention has the advantage that it improves the light efficiency of OLED devices employing color filter and color-change materials, and in certain embodiments improves the sharpness of an OLED device.

### BRIEF DESCRIPTION OF THE DRAWINGS

FIG. 1 illustrates a cross section of a top-emitter OLED device having a color filter and color-change materials according to one embodiment of the present invention;

FIG. 2 illustrates a cross section of a top-emitter OLED device having a color filter and color-change materials according to an alternative embodiment of the present invention;

FIG. 3 illustrates a cross section of a top-emitter OLED device having a scattering layer, a color filter, and color-change materials according to another embodiment of the present invention;

FIG. 4 illustrates a cross section of a top-emitter OLED device having a scattering layer, multiple color filters, and color-change materials according to another embodiment of the present invention;

FIG. 5 illustrates a cross section of a top-emitter OLED device having a scattering layer, color-change medium layer, color filters, and an encapsulation layer according to yet another embodiment of the present invention;

FIG. 6 illustrates a cross section of a top-emitter OLED device having a scattering layer, color-change medium layer, color filters, a white sub-pixel, and an encapsulation layer according to yet another embodiment of the present invention;

FIG. 7 illustrates a cross section of a top-emitter OLED device having scattering particles integrated into a color filter and into color change materials according to yet another embodiment of the present invention;

FIG. 8 illustrates a cross section of a top-emitter OLED device having scattering particles between reflective and transparent layers of a reflective electrode according to another embodiment of the present invention;

FIG. 9 illustrates a cross section of a prior-art bottom-emitter OLED device having trapped light; and

FIG. 10 illustrates a cross section of a prior-art bottom-emitter OLED device having a scattering surface and reduced sharpness.

It will be understood that the figures are not to scale since the individual layers are too thin and the thickness differences of various layers too great to permit depiction to scale.

### DETAILED DESCRIPTION OF THE INVENTION

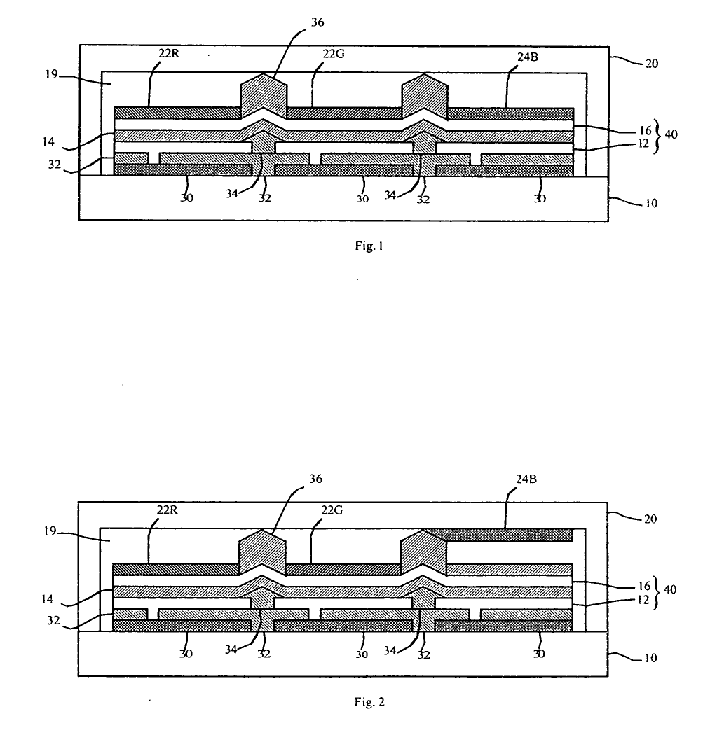

Referring to FIG. 1, in accordance with one embodiment of the present invention, a full-color organic light-emitting diode (OLED) 40 device comprises an OLED having a first patterned electrode 12 defining independently controllable light-emitting sub-pixels, a transparent second electrode 16, and one or more layers 14 of unpatterned organic material formed between the electrodes 12 and 16, wherein the organic material layer(s) 14 emit broadband light that contains blue and at least one other color of light, and a color-change material 22G that converts relatively higher frequency components of the broadband light to green light is correspondingly patterned with at least one of the sub-pixels to form a green sub-pixel, a color-change material 22R that converts relatively higher frequency components of the broadband light to red light is correspondingly patterned with at least one other of the sub-pixels to form a red sub-pixel, and a blue color filter 24B directly filtering emitted broadband light is correspondingly patterned with at least one additional other of the sub-pixels to form a blue sub-pixel. The blue color filter 24B may be located on or adjacent to the transparent electrode or protective layers formed on the electrode (16 in FIG. 1) or on an encapsulating cover 20 (as shown in FIG. 2). While the broadband light emitted by layer(s) 14 has a spectrum including blue and at least one other color of light, in preferred embodiments the broadband light spectrum preferable includes red, green and blue colored light, and most preferably comprises substantially white light.

The blue color filter directly filters the emitted broadband light. By directly filters is meant that no materials, for example color change materials, are employed to convert the broadband light emitted by the organic layer(s) 14 from one frequency to another prior to encountering the blue color filter. Use of such a color change material might reduce the color gamut of the OLED device by converting deeper blue frequency light to light that is more cyan or magenta. Moreover, use of a blue color-change material conversion medium as proposed in the prior art would practically require the use of organic light emitters having a higher percentage of emitted light at a higher frequency; such emitters are known to be relatively less efficient and to have reduced lifetimes than broadband light emitters not employing such high percentage of high frequency emissions. Blue light emitters themselves are also relatively inefficient and have limited lifetimes as compared to broadband emitters emitting blue light and at least one other color of light. Further, if an organic light emitter having a higher percentage of emitted light at a higher frequency was employed, the white point of the device might be negatively affected, in particular in combination with a four-color pixel OLED device such as a red, green, blue, and white (RGBW) pixilated device. If the spectral distribution of the emitted light were kept at a white point typically desired for OLED devices, the use of light-conversion materials would not effectively provide the desired color of blue, might absorb desired light, and would increase costs and reduce manufacturing yields. Use of directly filtered broadband light to provide a blue colored sub-pixel, in combination with color change materials to provide green and red colored sub-pixels thus enables full color devices to be made with high efficiency and desirable color gamut at reduced costs.

The color-change materials 22 and the blue color filter 24B are correspondingly patterned on the patterned electrode. Correspondingly patterned materials are located over the extent of the patterned electrode and in the direction of light emitted from the OLED device. In other words, the patterned color-change materials 22 and the blue color filter 24B will cover the patterned electrode, and the transparent electrode will be between the patterned color-change materials 22 and blue color filter 24B and the organic layer(s) 14.

In a particular embodiment, the light-emissive layer(s) 14 have a first refractive index range, and the transparent substrate 10 or cover 20 through which light from the OLED is emitted has a second refractive index. A light scattering layer 18 may be located adjacent to the transparent electrode to extract light that would otherwise be trapped in the organic layer(s) 14 and transparent electrode. A transparent low-index element 19 having a third refractive index lower than each of the first refractive index range and second refractive index may be located between the scattering layer 18 and the transparent substrate 10 or cover 20. OLED organic materials, color-change materials of various colors, substrates, covers, electrode materials, thin-film devices, and planarization layers are all known in the prior art and means for forming them into thin-film devices are also known.

In various embodiments, the present invention may be in a top-emitter configuration (as shown in FIG. 1) or a bottom-emitter configuration (not shown). In the top-emitter configuration of FIG. 1, light is emitted through the cover 20, the electrode 16 and cover 20 are typically transparent while the electrode 12 is reflective and the substrate 10 may be opaque, reflective, absorptive, or transparent. In a bottom-emitter configuration, light is emitted through the substrate 10, the electrode 12 and substrate 10 are typically transparent while the electrode 16 is reflective and the cover 20 may be opaque, reflective, absorptive, or transparent. In a typical configuration, the color-change materials 22, the scattering layer 18, and low-index layer 19 are located on the side of the transparent electrode opposite the organic layers 14.

The present invention may be employed in either a passive- or active-matrix configuration. In the active-matrix configuration of FIG. 1, thin-film electronic components 30 are formed on the substrate and electrically connected to patterned electrodes 12 to form sub-pixels. A planarization layer 32 protects the thin-film electronic components 30. A second planarization layer 34 separates the patterned electrodes 12.

In operation, the electrodes 12 and 16 provide a current through the unpatterned organic layer(s) 14, causing them to emit light. The emitted light then travels through the transparent electrode 16 to the color filter 24B and the color change materials 22R and 22G or is reflected from the reflective electrode 12 and then travels through the transparent electrode 16 to the color filter 24B and the color change materials 22R and 22G. Once the light is emitted into the color-change materials 22, lower frequency light may be transmitted through the color-change material and out of the device, while higher frequency light may be absorbed and re-emitted at a lower frequency. Light emitted into the color filter 24B is absorbed if it is not blue or transmitted out of the device if it is blue. However, light emitted by the organic layer(s) 14 and the color change materials 22 may be emitted in any direction and, as described above may be trapped in the device, reducing its efficiency. It is preferred that the scattering layer 18 also be in intimate optical contact with the color change material to prevent wave-guiding of light in the color change material layer, or an additional scattering layer may be provided to achieve such an effect.

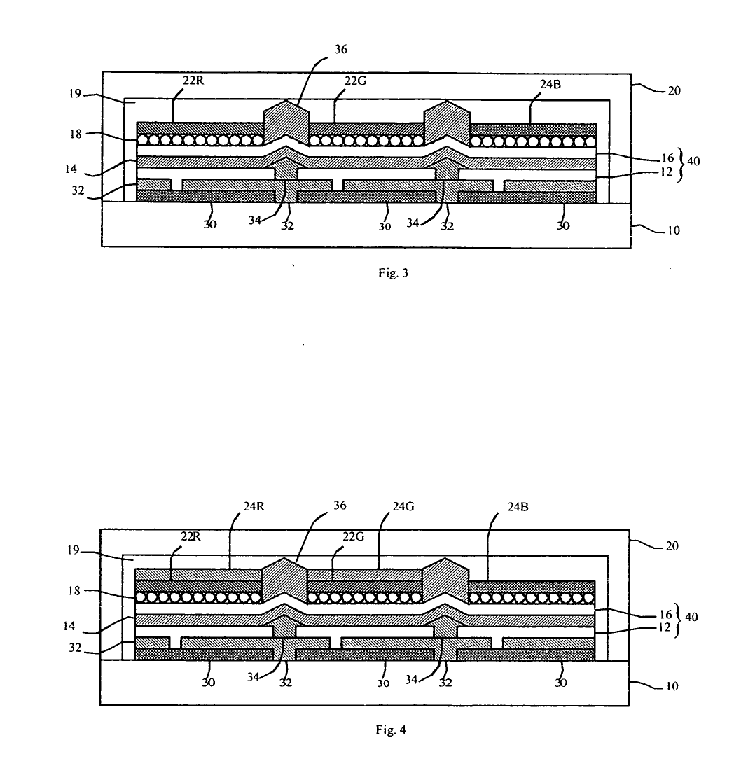

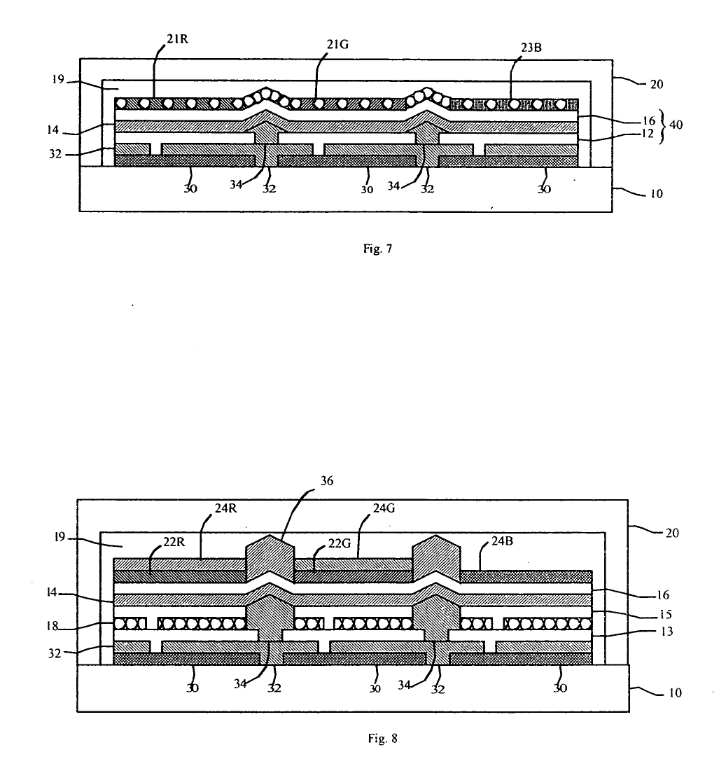

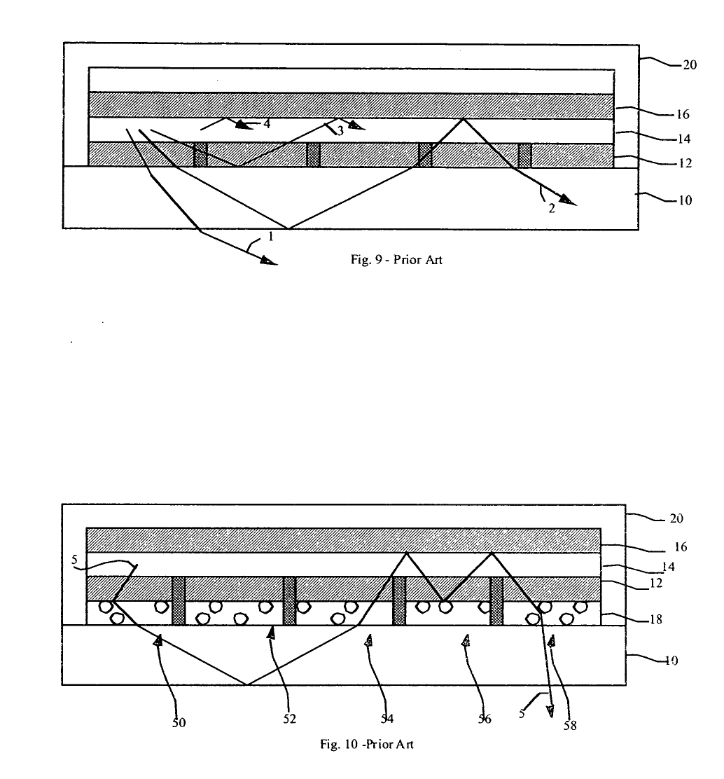

As illustrated in FIGS. 9 and 10, considerable light emitted by an OLED device may be trapped within the various layers of the OLED device. Referring to FIG. 3, by providing a scattering layer 18 and a low-index element 19, more light may be extracted from the OLED device. The emitted light travels through the transparent electrode 16 to the scattering layer 18 or is reflected from the reflective electrode 12 and then travels through the transparent electrode 16 to the scattering layer 18. After encountering the scattering layer, the light is scattered into the color-change materials 22R, 22G or blue filter 24B or back toward the reflective electrode 12 whence it again strikes the scattering layer 18 and is re-scattered until the light is eventually either emitted into the color-change materials 22 or filter 24B, or absorbed. Because the scattering layer 18 is in close optical contact with the transparent electrode 16, all of the emitted light (shown by light rays 1, 2, 3, and 4 in FIG. 7) is scattered and none is lost. Once the light is scattered into the color-change materials 22, it is either transmitted through the color-change material and into the low-index layer 19, reflected from the interface between the color-change material 22 and the low-index layer 19, or absorbed and re-emitted at the color frequency defined by the color-change material, for example, red, green, or blue. Light emitted by the color-change material 22 may be emitted at any angle. Once emitted by the color-change material, the light may pass into the low-index medium 19 and then through the cover 20. Because the low-index medium 19 has a lower optical index than the cover 20, light that passes from or through the color-change material 22 into the low-index medium 19 cannot be trapped in the cover 20 and then escapes from the OLED device. Similarly, if the emitted light passes into the blue color filter 24B (if the blue color filter 24B is formed on the transparent electrode) and then into the low-index medium 19, it can likewise escape from the OLED device because of the relatively lower index of the low-index medium 19. If the blue color filter 24B is formed on the encapsulating cover 20 such that the light passes into the low-index medium 19 and then into the blue color filter 24B, then the refractive index of layer 19 should also be lower than that of the blue color filter.

Emitted or re-emitted light that does not enter into the low-index medium 19 will enter or re-enter the scattering layer 18 and be scattered or re-scattered. If the light is scattered into an angle that allows the light to escape through the color-change material layer 22 into the low-index layer 19, it will escape from the OLED device. If the light is not scattered into an angle that allows the light to escape into the low-index layer 19, it will be either reflected from the interface between the color-change material 22 and the scattering layer 18 or be reflected from the reflective electrode 12, whence the light will eventually strike the scattering layer 18 again until it is eventually scattered into the low-index medium 19 and be emitted through the cover 20 or be absorbed. The color-change materials 22 may themselves provide some light scattering or an additional scattering layer may be provided over the color-change materials 22 or color filter 24B; in this case light that is scattered out of the color-change material layer 22 or color filter 24B and passes into the low-index layer 19 will also pass through the cover 20 and escape the device. Light that is scattered back toward the scattering layer 18 will again be scattered until it escapes the OLED device or is absorbed.

It is possible for the scattering layer 18 to be located above the color-change material. However, such a structure may not scatter all of the available light since some of the light emitted by the organic layer(s) 14 may be trapped within the organic layer(s) 14 and electrode 16 if the color-change material 22 has an optical index lower than that of the transparent electrode 16.

As shown in FIG. 4, in an alternative embodiment of the present invention, color filters 24R and 24G are correspondingly patterned in alignment with the color-change material 22 of the respective color so that the color filters 24R and 24G transmit light having a frequency range similar to the light emitted by the color change material 22. That is, a red color filter 24R is aligned with the red color-change material 22R and a green color filter 24G is aligned with the green color-change material 22G. By providing color filters 24R and 24G in combination with the color-change materials 22R and 22G, the color of the emitted light may be more strictly controlled, resulting in an improved color gamut. As shown in FIG. 4, the color filters 24R and 24G may be provided on the color-change material 22R and 22G with the low-index layer 19 between the color filters 24 and the cover 20 or the color filters 24R and 24G may be located on the inside or outside (FIG. 5) of the cover 20 so that the low-index layer 19 is between the color filters 24R and 24G and the color-change materials 22R and 24G.

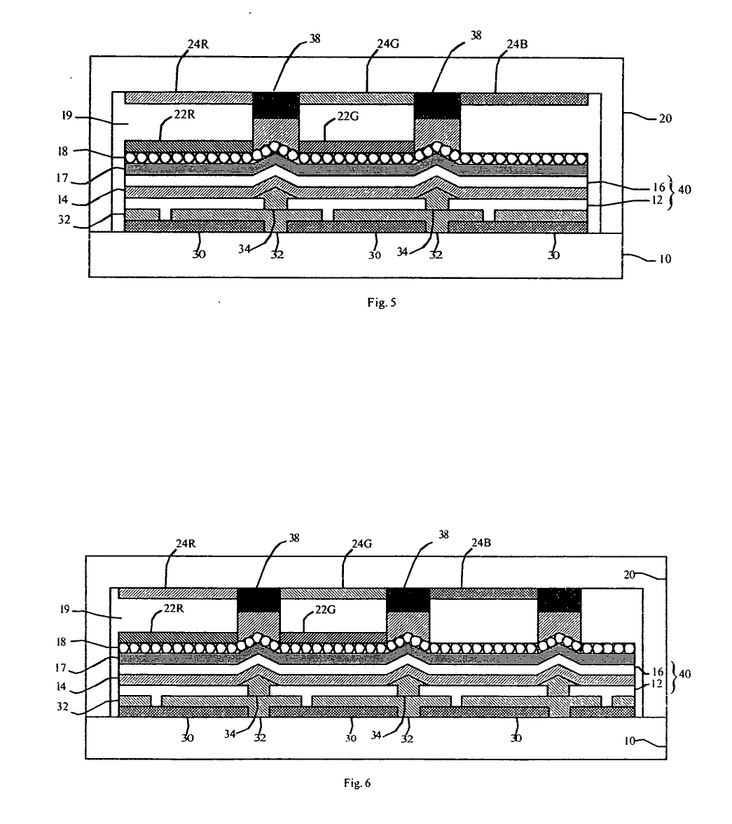

In an embodiment of the present invention, the broadband light emitted by organic material layer(s) 14 may be a substantially white light. Such a white light may be formed (for example) by employing two light-emitting organic layers each emitting different colors of light (such as blue and yellow) to form a broadband light that is substantially white. Referring to FIG. 6, such a white-light emitting layer may be employed to directly form a white sub-pixel, having no color filter or color-change material, in addition to the red, green and blue sub-pixels, to form a red, green, blue, and white (RGBW) pixilated device as is taught, for example, in U.S. Pat. No. 6,919,681. Such a design is useful because, in a conventional white-emitting OLED device with color filters, two thirds of the light may be lost by absorption into the color filters since the blue filter will absorb all of the red and green light, the green filter will absorb all of the blue and red light, and the red filter will absorb all of the blue and green light. However, by employing an unfiltered white emitter in combination with a red, green, and blue filtered emitter, a significant improvement in device efficiency may be obtained, depending on the content displayed on the OLED device. However, applicants have determined that the efficiency achieved is heavily dependent on the color of the white emitter. If the white emitter does not emit light at, or close to, the white point of the display (for example a D65 white point), the efficiency of the display device is greatly decreased. Hence, it is greatly preferred that the color of the white light emitted by an OLED device employing a white sub-pixel be very near the device white point.

According to an embodiment of the present invention, the efficiency of a white-emitting OLED device may be further improved by employing green and red color-change materials with the red and green sub-pixels. In this case, the green color-change material can convert the blue light into green light while red light is still absorbed by the green color filter, thereby improving the efficiency of the green pixel. The red color-change material can convert both the blue light and the green light into red light so that no emitted light is absorbed by the color filter, thereby theoretically doubling the overall efficiency of the device and, in an RGBW device, theoretically increasing the efficiency by 1.5 times. The red color filter may be employed to further trim the spectrum of the emitted light and, together with the blue and green color filters, absorb ambient light to improve the device contrast. In this embodiment, only the scattering layer 18 may be provided over the white sub-pixel element. Other color sub-pixels, for example cyan or yellow, may also be employed and color-change materials and/or color filters employed to improve the efficiency and color purity of the pixels.

Light absorbing, black matrix materials may also be employed between the color filters to further improve the absorption of ambient light. Such black matrix materials may be formed from carbon black in a polymeric binder and located either on the cover 20 (as shown in FIG. 5, element 38) or formed on the OLED (as shown in FIGS. 1, 2, 3, and 4, raised area element 36) and employed to separate patterned color filter 24 or color-change materials 22 and provide a standoff forming a low-index layer 19. Black matrix materials are well-known and may, for example, comprise a polymer or resin with carbon black.

OLED protective layers may also be employed over the OLED organic layer(s) 14 and transparent electrode 16 to protect the OLED from environmental contamination such as water vapor or mechanical stress. In such cases, the scattering layer may be located over the protective layers. Referring to FIGS. 5 and 6, a protective layer 17 is employed to protect the OLED layer(s) 14 and the transparent electrode 16.

In an alternative embodiment of the present invention, the scattering layer and the color-change materials may be incorporated into a common layer. Referring to FIG. 7, a patterned layer scatters light emitted through the transparent electrode 16. Color-change materials 21R and 21G incorporated into the patterned layers convert the scattered light into red or green light respectively while filter 23B scatters and filters blue light. Such layers may be formed from large color-change or filter material particles, for example having an average diameter greater than 500 nm and formed within a relatively low-index material such as a polymer. Alternatively, small color-change or filter material particles having an average diameter less than or equal to 200 nm mixed with high-index particles such as titanium dioxide having an average diameter greater than 500 nm may be employed.

According to the present invention, the transparent low-index element 19 may be located anywhere in the OLED device between scattering layer 18 and the encapsulating cover 20 (for a top-emitter) or between scattering layer 18 and the substrate 10 (for a bottom-emitter). Hence, in various embodiments the scattering layer 18 may be adjacent to either electrode 12 or 16 opposite the organic layers 14. In yet another embodiment, the reflective electrode 12 may comprise multiple layers, for example a transparent, electrically conductive layer 15 and a reflective layer 13, as shown in FIG. 8. The scattering layer may be located between the reflective layer 13 and the transparent, electrically conductive layer 15. The reflective layer 13 may also be conductive, as may the scattering layer 18. In this case, it is preferred that the transparent, conducting layer 15 have a refractive index in the first refractive index range.

In preferred embodiments, the encapsulating cover 20 and substrate 10 may comprise glass or plastic with typical refractive indices of between 1.4 and 1.6. The transparent low-index element 19 may comprise a solid layer of optically transparent material, a void, or a gap. Voids or gaps may be a vacuum or filled with an optically transparent gas or liquid material. For example air, nitrogen, helium, or argon all have a refractive index of between 1.0 and 1.1 and may be employed. Lower index solids which may be employed include fluorocarbon or MgF, each having indices less than 1.4. Any gas employed is preferably inert. Reflective electrode 12 is preferably made of metal (for example aluminum, silver, or magnesium) or metal alloys. Transparent electrode 16 is preferably made of transparent conductive materials, for example indium tin oxide (ITO) or other metal oxides. The organic material layer(s) 14 may comprise organic materials known in the art, for example, hole-injection, hole-transport, light-emitting, electron-injection, and/or electron-transport layers. Such organic material layers are well known in the OLED art. The organic material layers typically have a refractive index of between 1.6 and 1.9, while indium tin oxide has a refractive index of approximately 1.8-2.1. Hence, the various layers organic and transparent electrode layers in the OLED have a refractive index range of 1.6 to 2.1. Of course, the refractive indices of various materials may be dependent on the wavelength of light passing through them, so the refractive index values cited here for these materials are only approximate. In any case, the transparent low-index element 19 preferably has a refractive index at least 0.1 lower than that of each of the first refractive index range and the second refractive index at the desired wavelength for the OLED emitter.

Scattering layer 18 may comprise a volume scattering layer or a surface scattering layer. In certain embodiments, e.g., scattering layer 18 may comprise materials having at least two different refractive indices. The scattering layer 18 may comprise, e.g., a matrix of lower refractive index and scattering elements have a higher refractive index. Alternatively, the matrix may have a higher refractive index and the scattering elements may have a lower refractive index. For example, the matrix may comprise silicon dioxide or cross-linked resin having indices of approximately 1.5, or silicon nitride with a much higher index of refraction. If scattering layer 18 has a thickness greater than one-tenth part of the wavelength of the emitted light, then it is desirable for the index of refraction of at least one material in the scattering layer 18 to be approximately equal to or greater than the first refractive index range. This is to insure that all of the light trapped in the organic layers 14 and transparent electrode 16 can experience the direction altering effects of scattering layer 18. If scattering layer 18 has a thickness less than one-tenth part of the wavelength of the emitted light, then the materials in the scattering layer need not have such a preference for their refractive indices.

In an alternative embodiment, scattering layer 18 may comprise particles deposited on another layer, e.g., particles of titanium dioxide may be coated over transparent electrode 16 to scatter light. Preferably, such particles are at least 100 nm in diameter to optimize the scattering of visible light. In a further alternative, scattering layer 18 may comprise a rough, diffusely reflecting or refracting surface of electrode 12 or 16 itself.

The scattering layer 18 is typically adjacent to and in contact with, or close to, an electrode to defeat total internal reflection in the organic layers 14 and transparent electrode 16. However, if the scattering layer 18 is between the electrodes 12 and 16, it may not be necessary for the scattering layer to be in contact with an electrode 12 or 16 so long as it does not unduly disturb the generation of light in the OLED layers 14. According to an embodiment of the present invention, light emitted from the organic layers 14 can waveguide along the organic layers 14 and electrode 16 combined, since the organic layers 14 have a refractive index lower than that of the transparent electrode 16 and electrode 12 is reflective. The scattering layer 18 or surface disrupts the total internal reflection of light in the combined layers 14 and 16 and redirects some portion of the light out of the combined layers 14 and 16. To facilitate this effect, the transparent low-index element 19 should not itself scatter light, and should be as transparent as possible. The transparent low-index element 19 is preferably at least one micron thick to ensure that emitted light properly propagates through the transparent low-index element and is transmitted through the encapsulating cover 20.

It is important to note that a scattering layer will also scatter light that would have been emitted out of the device back into the layers 14, exactly the opposite of the desired effect. Hence, the use of optically transparent layers that are as thin as possible is desired in order to extract light from the device with as few reflections as possible.

Whenever light crosses an interface between two layers of differing index (except for the case of total internal reflection), a portion of the light is reflected and another portion is refracted. Unwanted reflections can be reduced by the application of standard thin anti-reflection layers. Use of anti-reflection layers may be particularly useful on both sides of the encapsulating cover 20, for top emitters, and on both sides of the transparent substrate 10, for bottom emitters.

The transparent low-index element 19 is useful for extracting additional light from the OLED device. However, in practice, if a void or gap (filled with a gas or is a vacuum) is employed in a top-emitter configuration as a transparent low-index element 19, the mechanical stability of the device may be affected, particularly for large devices. For example, if the OLED device is inadvertently curved or bent, or the encapsulating cover 20 or substrate 10 are deformed, the encapsulating cover 20 may come in contact with the color change and filter materials on transparent electrode 16 and damage it or the underlying organic layers. Hence, some means of preventing the encapsulating cover 20 from contacting the OLED device layers in a top-emitter OLED device may be useful. According to another top-emitter embodiment of the present invention, the organic material layer(s) 14 and the electrodes 12 and 16 may be surrounded, partially or entirely, by a raised area 36 (see, e.g., FIG. 3) formed, for example, by planarization material. The raised area can be in contact with the encapsulating cover 20. By providing a mechanical contact between the encapsulating cover 20 and the substrate 10 within or around the light-emitting area of the device, the OLED device can be made more rigid and a gap or void serving as transparent low-index element 19 created. Alternatively, if flexible substrates 10 and covers 20 are employed, the raised areas can prevent the encapsulating cover 20 from touching the OLED device material layers. Such raised areas may be made from patterned insulative materials employed in photo-lithographic processes for thin-film transistors construction in active-matrix devices. The scattering layer 18 may, or may not, be coated over the raised areas.

The raised areas may be provided with reflective edges to assist with light emission for the light that is emitted toward the edges of each light-emitting area. Alternatively, the raised areas may be opaque or light absorbing. Preferably, the sides of the raised areas are reflective while the tops may be black and light absorbing. A light-absorbing surface or coating will absorb ambient light incident on the OLED device, thereby improving the contrast of the device. Reflective coatings may be applied by evaporating thin metal layers. Light absorbing materials may employ, for example, color filters material known in the art. Raised areas within an OLED device are also known in the art and are found, for example in Kodak OLED products such as the ALE251, to protect thin-film transistors and conductive contacts. Construction and deposition techniques are known in the art. A useful height for the raised area above the surface of the OLED is one micron or greater. An adhesive may be employed on the encapsulating cover 20 or raised areas to affix the encapsulating cover 20 to the raised areas to provide additional mechanical strength.

The scattering layer 18 can employ a variety of materials. For example, randomly located spheres of titanium dioxide may be employed in a matrix of polymeric material. Alternatively, a more structured arrangement employing ITO, silicon oxides, or silicon nitrides may be used. In a further embodiment, the refractive materials may be incorporated into the electrode itself so that the electrode is a scattering layer. Shapes of refractive elements may be cylindrical, rectangular, or spherical, but it is understood that the shape is not limited thereto. The difference in refractive indices between materials in the scattering layer 18 may be, for example, from 0.3 to 3, and a large difference is generally desired. The thickness of the scattering layer, or size of features in, or on the surface of, a scattering layer may be, for example, 0.03 to 50 μm. It is generally preferred to avoid diffractive effects in the scattering layer. Such effects may be avoided, for example, by locating features randomly or by ensuring that the sizes or distribution of the refractive elements are not the same as the wavelength of the color of light emitted by the device from the light-emitting area.

The scattering layer 18 should be selected to get the light out of the OLED as quickly as possible so as to reduce the opportunities for re-absorption by the various layers of the OLED device. If the scattering layer 18 is to be located between the organic layers 14 and the transparent low-index element 19, or between the organic layers 14 and a reflective electrode 12, then the total diffuse transmittance of the same layer coated on a glass support should be high (preferably greater than 80%). In other embodiments, where the scattering layer 18 is itself desired to be reflective, then the total diffuse reflectance of the same layer coated on a glass support should be high (preferably greater than 80%). In all cases, the absorption of the scattering layer should be as low as possible (preferably less than 5%, and ideally 0%).

Materials of the light scattering layer 18 can include organic materials (for example polymers or electrically conductive polymers) or inorganic materials. The organic materials may include, e.g., one or more of polythiophene, PEDOT, PET, or PEN. The inorganic materials may include, e.g., one or more of SiOₓ (x>1), SiNₓ (x>1), Si₃N₄, TiO₂, MgO, ZnO, Al₂O₃, SnO₂, In₂O₃, MgF₂, and CaF₂. The scattering layer 18 may comprise, for example, silicon oxides and silicon nitrides having a refractive index of 1.6 to 1.8 and doped with titanium dioxide having a refractive index of 2.5 to 3. Polymeric materials having refractive indices in the range of 1.4 to 1.6 may be employed having a dispersion of refractive elements of material with a higher refractive index, for example titanium dioxide.

Conventional lithographic means can be used to create the scattering layer using, for example, photo-resist, mask exposures, and etching as known in the art. Alternatively, coating may be employed in which a liquid, for example polymer having a dispersion of titanium dioxide, may form a scattering layer 18.

One problem that may be encountered with such scattering layers is that the electrodes may tend to fail open at sharp edges associated with the scattering elements in the layer 18. Although the scattering layer may be planarized, typically such operations do not form a perfectly smooth, defect-free surface. To reduce the possibility of shorts between the electrodes 12 and 16, a short-reduction layer may be employed between the electrodes. Such a layer is a thin layer of high-resistance material (for example having a through-thickness resistivity between 10⁻⁷ ohm-cm² to 10³ ohm-cm²). Because the short-reduction layer is very thin, device current can pass between the electrodes through the device layers but leakage current through the shorts are much reduced. Such layers are described in US2005/0225234, filed Apr. 12, 2004, the disclosure of which is incorporated herein by reference.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890 issued May 8, 2001 to Boroson et al. In addition, barrier layers such as SiOₓ (x>1), Teflon, and alternating inorganic/polymeric layers are known in the art for encapsulation.

In particular, as illustrated in FIGS. 5 and 6, very thin layers 17 of transparent encapsulating materials may be deposited on the electrode. In this case, the scattering layer 18 may be deposited over the layers 17 of encapsulating materials. This structure has the advantage of protecting the electrode 16 during the deposition of the scattering layer 18. Preferably, the layers 17 of transparent encapsulating material have a refractive index comparable to the first refractive index range of the transparent electrode 16 and organic layers 14, or is very thin (e.g., less than about 0.2 micron) so that wave guided light in the transparent electrode 16 and organic layers 14 will pass through the layers of transparent encapsulating material 17 and be scattered by the scattering layer 18.

OLED devices of this invention can employ various well-known optical effects in order to enhance their properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing neutral density filters over the display. Filters, polarizers, and anti-glare or anti-reflection coatings may be specifically provided over the cover or as part of the cover.

The present invention may also be practiced with either active- or passive-matrix OLED devices. It may also be employed in display devices. In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays having either a top- or bottom-emitter architecture.

Color change materials that may be employed in the present invention are themselves also well-known. Such materials are typically fluorescent and/or phosphorescent materials that absorb light at higher frequencies (shorter wavelengths, e.g. blue) and emit light at different and lower frequencies (longer wavelengths, e.g. green or red). Such materials that may be employed for use in OLED devices in accordance with the present invention are disclosed, e.g., in U.S. Pat. Nos. 5,126,214, 5,294,870, and 6,137,459, US2005/0057176 and US2005/0057177, the disclosures of which are incorporated by reference herein.

The invention has been described in detail with particular reference to certain preferred embodiments thereof, but it will be understood that variations and modifications can be effected within the spirit and scope of the invention.

1. A full-color organic light-emitting diode (OLED) device, comprising:
an OLED having a first patterned electrode defining independently controllable light-emitting sub-pixels, and a second electrode, wherein at least one of the first or second electrodes is transparent and one or more layers of unpatterned organic material formed between the electrodes;
wherein the organic material layer(s) emit broadband light that contains blue and at least one other color of light, and a color-change material that converts relatively higher frequency components of the broadband light to green light is correspondingly patterned with at least one of the sub-pixels to form a green sub-pixel, a color-change material that converts relatively higher frequency components of the broadband light to red light is correspondingly patterned with at least one other of the sub-pixels to form a red sub-pixel, and a blue color filter directly filtering emitted broadband light is correspondingly patterned with at least one additional other of the sub-pixels to form a blue sub-pixel.

2. The full-color organic light-emitting diode (OLED) device of claim 1 further comprising green color filters correspondingly patterned with the green sub-pixels and/or red color filters correspondingly patterned with the red sub-pixels.

3. The full-color organic light-emitting diode (OLED) device claimed in claim 1, wherein the broadband light is substantially white.

4. The full-color organic light-emitting diode (OLED) device of claim 3 further comprising white sub-pixels patterned by the first patterned electrode.

5. The full-color organic light-emitting diode (OLED) device of claim 4, wherein the independently controllable sub-pixels are grouped into full-color pixels having a red, green, blue, and a white light emitter.

6. The full-color organic light-emitting diode (OLED) device claimed in claim 1, wherein the organic layers include two light-emitting layers emitting different colors of light to form a broadband light that is substantially white.

7. The full-color organic light-emitting diode (OLED) device of claim 1 further comprising a color-change material that converts blue light to yellow light patterned over at least one sub-pixel to form a yellow sub-pixel or a color-change material that converts blue light to cyan light patterned over at least one sub-pixel to form a cyan sub-pixel.

8. The full-color organic light-emitting diode (OLED) device of claim 1, further comprising a substrate and an encapsulating cover, a light scattering layer located adjacent to the transparent electrode, the layer(s) of organic light-emitting material having a first refractive index range; and wherein at least one of the substrate or cover comprises a transparent substrate or cover having a second refractive index and through which light from the OLED is emitted;
and further comprising a transparent low-index element having a third refractive index lower than each of the first refractive index range and second refractive index and located between the scattering layer and the transparent substrate or cover.

9. The full-color organic light-emitting diode (OLED) device of claim 8 wherein the scattering layer is formed between the transparent electrode, and the color-change material or the color filters.

10. The full-color organic light-emitting diode (OLED) device of claim 8 wherein the transparent low-index element is formed between the cover and the color-change material or the color filters.

11. The full-color organic light-emitting diode (OLED) device of claim 8 wherein the transparent low-index element is formed between the color filters and the color-change material and the transparent electrode.

12. The full-color organic light-emitting diode (OLED) device of claim 1 wherein the color-change material is a scattering layer.

13. The full-color organic light-emitting diode (OLED) device of claim 1 further comprising one or more protective layers formed between the transparent electrode and the scattering layer.

14. The full-color organic light-emitting diode (OLED) device of claim 1 further wherein the other of the first or second electrodes is reflective.

15. The full-color organic light-emitting diode (OLED) device of claim 18 wherein the reflective electrode comprises a transparent electrode and a reflective layer and wherein the scattering layer is formed between the transparent electrode and the reflective layer.
